(19) United States
(12) Patent Application Publication
(10) Pub. No.: US 2008/0307446 A1
(43) Pub. Date: Dec. 11, 2008

(54) Interoperable Managed and Unmanaged Code in a Document Environment

(75) Inventor: Iouri B Simernitski, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/760,529

(22) Filed: Jun. 8, 2007

(51) Int. Cl. G06F 13/00

(52) U.S. Cl. 719/331

(57) ABSTRACT

Managed and unmanaged code may operate in a document environment by enabling managed code to be called by unmanaged code. The managed code may make functions available to unmanaged code by creating a type library and loading the type library into a running object table using a filename identifier. The filename identifier may be used by the unmanaged code to locate the type library and thereby call managed code functions.

### BACKGROUND

Managed code is a relative newcomer to computer programming technology. Managed code is a term that is used to describe programs or applications that are executed in a virtual machine or other environment that may provide a group of services above and beyond what a typical operating system may provide. The managed code environment may provide some complex services used to link and execute various portions of executable code. Managed code is often portable between platforms so that a single application may be operated on systems with different hardware or other characteristics. Some managed code may be compiled from different programming languages into a commonly defined intermediate language.

Unmanaged code typically may be compiled or developed for a specific computing platform. Such code may be re-compiled for use on a different platform and typically is compiled directly into an executable format.

There are many applications written in unmanaged code, however, managed code offers an increasingly vast array of functions for network operations, communications, and other newer technologies.

### SUMMARY

Managed and unmanaged code may operate in a document environment by enabling managed code to be called by unmanaged code. The managed code may make functions available to unmanaged code by creating a type library and loading the type library into a running object table using a filename identifier. The filename identifier may be used by the unmanaged code to locate the type library and thereby call managed code functions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a system with interoperable code.

FIG. 2 is a flowchart illustration of an embodiment showing a method for interchangeable code.

### DETAILED DESCRIPTION

Managed code may be called from unmanaged code in a document environment by loading a type library into the running object table. Unmanaged code may locate the type library in the running object table and thereby call functions within the managed code environment.

During development, a type library identifier may be defined within the managed code environment. The identifier may be used by the unmanaged code to locate the type library. In some instances, the identifier may be used to find the type library as a standalone file in a directory structure, while in other instances, the identifier may be used to locate the type library in the running object table. The identifier may be hardcoded into the unmanaged code so that the type library may be loaded during the startup phase of execution.

In the development phase, the type library may be built up in the managed code environment and made available to development tools used for the unmanaged code. In some cases, the type library may be used in a development tool to insert the name of a managed code function to be called from the unmanaged code.

Throughout this specification and claims, references made to managed code may include any type of programming and execution system that uses a virtual machine or other virtualized environment. In many embodiments, managed code may be compiled into an intermediate code that is interpreted or compiled using a just in time compiler at runtime. Managed code may be portable between different platforms, with machine specific just in time compilers used on different platforms.

Additionally, throughout this specification and claims, the term unmanaged code shall be used to define code that may be executed directly within the operating system environment. Unmanaged code may be interpreted or compiled. In many embodiments, managed code may be more technologically advanced than unmanaged code. In many embodiments, there may be mechanisms or procedures whereby unmanaged code may be called by managed code.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

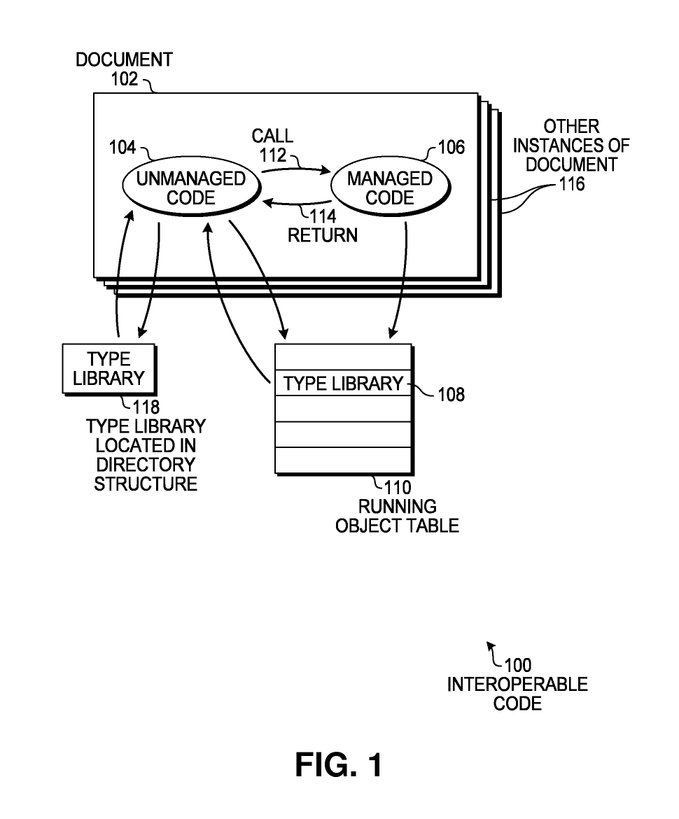

FIG. 1 is a diagram of an embodiment 100 showing a system where unmanaged code may call managed code using a type library produced by the managed code. The code is operated in a document environment, where the code is embedded or linked into a document and operable within the document. In embodiment 100, multiple instances of a document may use the type library from a location within a file system or from within the running object table.

The document 102 is shown containing unmanaged code 104 and managed code 106. In a typical embodiment, the document 102 may be a word processing document, spreadsheet, presentation, or other document that supports embedded macros or other executable code. The unmanaged code 104 may be a language such as Visual Basic for Applications and the managed code 106 may be a language such as Visual Studio Tools for Office, both of which are produced by Microsoft Corporation. Other versions and types of managed and unmanaged code may also be used by various manufacturers.

The managed code 106 may create a type library that may be stored in a file located in a directory structure 118. Additionally, the managed code 106 may insert the type library 108 into the running object table 110 when the managed code 106 is executed.

The unmanaged code 104 may have an embedded identifier that enables the unmanaged code 104 to locate the type library. The identifier may be a filename which may have an associated directory path that enables the type library 118 to be found as a standalone file. If the type library 118 is not found in a directory structure, the unmanaged code 104 may search through the running object table 110 to find the type library 108.

Using either of the type libraries 108 or 118, the unmanaged code 104 may make a call 112 to the managed code 106, which may cause a function within the managed code 106 to be executed. After execution, a return 114 may pass information and/or control back to the unmanaged code 104.

When the managed code 106 begins execution, may detect that portions of the managed code 106 may be called by the unmanaged code 104. After detecting, the managed code 106 may load the type library 108 in the running object table 110. The type library 108 may be identified with a filename, GUID, or other identifier.

In some cases, a pointer may be loaded into the running object table 110 rather than the type library 108. The pointer may point to a file or other location where the type library data may be stored. The location may be created or loaded with data at the beginning of execution or may be a file or other location that exists before execution begins.

In some embodiments, multiple instances 116 of the document 102 may be open and operating. In some cases, each instance 116 may reference the same type library. In such cases, each call 112 to the managed code 106 may include a variable that defines the particular instance of unmanaged code that may be making the call 112.

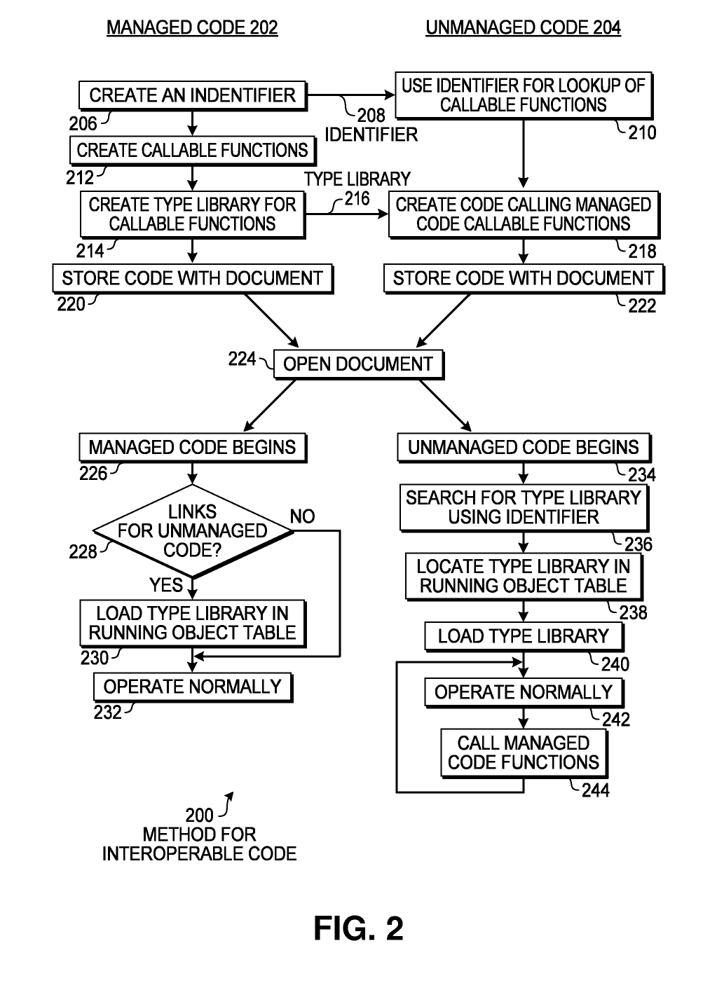

FIG. 2 is a flowchart illustration of an embodiment 200 of a method for interoperable code. The actions of managed code 202 are shown on the left column and actions of unmanaged code 204 on the right.

Embodiment 200 illustrates both the development and execution phase of the managed and unmanaged code in a document environment. During development, an identifier may be created and shared between the managed code and unmanaged code environments. A type library may be created, populated, and used by the unmanaged code to create calls to the managed code.

After a document is opened, execution begins. The managed code may load a type library in a location for the unmanaged code to find and use to make calls into the managed code.

The embodiment 200 may illustrate one method by which unmanaged code may make calls into a managed code environment. Embodiment 200 is an example of how an identifier may be shared between managed and unmanaged code during the development phase, and how the identifier may be used to locate a type library by the unmanaged code. Other methods and variations of methods may also be used.

Within the managed code 202, an identifier may be created in block 206. The identifier may be a filename, globally unique identifier (GUID), or other any other identifier. Some identifiers may include multiple parts, such as an identifier that may include a short filename as well as a GUID. In some cases, a filename may include a directory path.

The identifier 208 may be used by the unmanaged code 204 for lookup of callable functions in block 210. In some embodiments, the identifier may be hard coded into the unmanaged code 204. The unmanaged code 204 may be adapted to search for a type library or other information using the identifier 208 in order to call functions in the managed code 202.

In block 212, callable functions may be created in the managed code 202. The callable functions may be any type of function able to be executed in the managed code environment, and may be exposed to the unmanaged code 204. A type library may be created in block 214 for the callable functions. The type library 216 may be transmitted to the unmanaged code 204 and used to create code calling the managed code functions in block 218.

In many embodiments, the unmanaged code 204 may be created using an editing environment that may use a type library 216 to speed entry of a callable function when writing the code. The type library 216 may also be used to verify proper spelling of the callable functions and provide other information to the developer of unmanaged code 204.

After completing development of the managed code 202, the managed code is stored with a document in block 220. Similarly, the unmanaged code 204 is stored with the document in block 222.

The document may be any type of document, such as a word processing document, spreadsheet, web page, database, presentation, email, image, graphic, or any other document. In general, a document may be any computer file that contains information that may be processed by an application. In many instances, a document may contain embedded code or other code that may be executed while the document is open. In many cases, such code may have a portion of which that is executed when the document is open and other portions may be executed at a later time during editing, viewing, or manipulating the data within the document.

Many documents may have languages for creating interpreted or compiled code that performs specific functions. For example, a small piece of code may verify a calculation within a word processing document or perform a save operation with particular parameters. Such code may be written in any type of computer language.

In many cases, a document may have a variety of languages from which a developer may choose to perform various functions. Some languages may be designed to perform some functions particularly well or have libraries or functions adapted to perform specific operations, while other languages may be suited for different operations.

There may be many cases where a developer may wish to take advantage of an operation or library of functions that are available in a managed code environment but also use particular functions in an unmanaged code environment. In some cases, a large application or set of functions may have been developed in an unmanaged code environment before a managed code environment was available. Certain functions may be easier to deploy in a managed code environment but may be designed to be called from the legacy unmanaged code environment.

When the document is opened in block 224, the managed code begins operation in block 226 and the unmanaged code begins operation in block 234.

If the managed code 202 has links to managed code in block 228, the type library may be loaded into the running object table in block 230. Otherwise, the step of block 230 may be skipped and the managed code may begin normal operation in block 232. During normal operation in block 232, the unmanaged code 204 may call certain functions within the managed code.

After beginning operation in block 234, the unmanaged code 204 may search for the type library using the identifier in block 236. The identifier may be any type of identifier or pointer that enables the unmanaged code 204 to locate the type library. In some instances, the identifier may be a filename that may be located within a file structure. In some cases, the filename identifier may also be found in the running object table in block 238 and used to locate the type library.

In some instances, the managed code 202 may load the actual type library into the running object table in block 230 for the unmanaged code 204 to find in block 238. In other instances, the managed code 202 may load a pointer or other mechanism into the running object table in block 230 so that the unmanaged code 204 may find the pointer in block 238 and follow the pointer or use the pointer to locate the type library.

Once the type library is found, the type library is loaded in block 240. The unmanaged code 204 may operate normally in block 242 and occasionally call managed code functions in block 244.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
defining an identifier for a first group of managed code;
defining a callable function within said first group of managed code;
defining a type library for said callable function;
adding said identifier to a second group of unmanaged code, said second group of unmanaged code adapted to:
search for said type library using said identifier;
finding said identifier in said running object table;
loading said type library from said running object table; and
calling said callable function.

2. The method of claim 1, said identifier comprising a filename.

3. The method of claim 1, said identifier comprising a GUID.

4. The method of claim 1, said identifier being hardcoded within said second group of unmanaged code.

5. The method of claim 1, said managed code and said unmanaged code being callable from a document environment.

6. A computer readable medium comprising computer executable instructions adapted to perform the method of claim 1.

7. A method comprising:
detecting that a document has been opened, said document comprising managed and unmanaged code adapted to be executed within a document environment;
executing said managed code, said managed code comprising an identifier and a type library; and
executing said unmanaged code, said unmanaged code adapted to:
search for said type library using said identifier; and
call at least a portion of said managed code using said type library.

8. The method of claim 7, said managed code being adapted to load said type library in a running object table.

9. The method of claim 7, said type library being located in a file.

10. The method of claim 9, said identifier comprising a directory path for said file.

11. The method of claim 7, said identifier comprising a GUID.

12. The method of claim 7, said calling comprising identifying an instance of said document from which said at least a portion of said managed code is being called.

13. The method of claim 7, said managed code being adapted to detect that said unmanaged code is adapted to call said managed code.

14. A computer readable medium comprising computer executable instructions adapted to perform the method of claim 7.

15. A method comprising:
receiving an identifier for a type library within an unmanaged code environment, said type library comprising a reference to a managed code environment;
searching for said type library using said identifier;
finding said type library in a running object table; and
making a call to said managed code environment from said unmanaged code environment using said type library.

16. The method of claim 15, said identifier comprising a file name.

17. The method of claim 15, said identifier comprising a GUID.

18. The method of claim 15, said managed code environment and said unmanaged code environment being called from within a document environment.

19. The method of claim 18, said making a call comprising an instance identifier for said document environment.

20. A computer readable medium comprising computer executable instructions adapted to perform the method of claim 15.
